(19) United States
(12) Patent Application Publication
(10) Pub. No.: US 2016/0252743 A1
(43) Pub. Date: Sep. 1, 2016

(54) DIFFRACTION GRATING LENS, DESIGN METHOD FOR OPTICAL SYSTEM HAVING SAME, IMAGE COMPUTATION PROGRAM, AND PRODUCTION METHOD FOR DIFFRACTION GRATING LENS

(71) Applicant: PANASONIC INTELLECTUAL PROPERTY MANAGEMENT CO., LTD., Osaka (JP)

(72) Inventor: TAKAMASA ANDO, Osaka (JP)

(21) Appl. No.: 15/026,654

(22) PCT Filed: Sep. 5, 2014
(86) PCT No.: PCT/JP2014/004572

§ 371 Date: Apr. 1, 2016

(30) Foreign Application Priority Data
Oct. 22, 2013 (JP) 2013-219364

(51) Int. Cl. G02B 27/42; G02B 5/18; G06F 17/50; G02B 27/00

(52) U.S. Cl. CPC G02B 27/4266; G02B 27/0012; G02B 5/1876; G02B 5/1814; G02B 27/0018; G02B 27/4205; G06F 17/50

(57) ABSTRACT

A method for designing an optical system having a stepped diffraction grating surface includes a flare computation step of defining a temporary shape of the diffraction grating surface and computing a flare amount, and a determination step of determining whether or not the flare amount is within a permissible range, and setting the temporary shape as a shape of the diffraction grating surface if the flare amount is within the permissible range, and returning to the flare computation step if the flare amount is out of the permissible range. The flare computation step includes a temporary shape definition step of defining the temporary shape, a phase computation step of conducting ray tracing from an object surface to an image surface of the optical system at a predetermined field angle, using the temporary shape to find phase information, a pupil distribution computation step of finding pupil distribution on an exit pupil, based on the phase information, and a point image distribution computation step of finding point image distribution on the image surface from the pupil distribution, using a wave propagation analysis method to compute the flare amount.

### TECHNICAL FIELD

The present invention relates to a diffraction grating lens that brings about a small generation amount of flare, a method for designing an optical system having the diffraction grating lens, an image computation program, and a method for manufacturing the diffraction grating lens.

### BACKGROUND ART

A diffraction optical element in which a stepped diffraction grating is provided in a lens base, and condensing or dispersion of light is performed, using a diffraction phenomenon is called a diffraction grating lens. It is widely known that the diffraction grating lens is excellent in correcting aberration of a lens such as field curvature, chromatic aberration, and the like. This is because the diffraction grating has dispersibility reverse to dispersibility generated by an optical material (reverse dispersibility), dispersibility that deviates from linearity of dispersion of the optical material (abnormal dispersibility). Therefore, combining the diffraction grating lens with a normal optical element allows the diffraction grating lens to exert a larger chromatic aberration correction capability, so that the diffraction grating lens is used as a lens of an imaging device.

The above-described diffraction grating lens is designed by a method called ray tracing (for example, refer to NPL 1). FIG. 7 is a diagram showing diffraction grating surface 101 in simulation using conventional ray tracing. Outgoing ray 102 is a ray resulting from refracting an incident ray by an aspherical shape of the lens at diffraction grating surface 101. Outgoing ray 103 is a ray resulting from applying a diffraction component by a phase function to the incident ray at the diffraction grating surface in addition to the refraction by the aspherical shape. A difference between outgoing ray 102 and outgoing ray 103 is an effect by the diffraction. A direction of the refraction at diffraction grating surface 101 is represented by the following expressions.

$$\begin{matrix}{n}_{1} ( {S}_{1} \times E ) = {n}_{0} ( {S}_{0} \times E ) + m \frac{λ}{{λ}_{0}} ∇ ψ ( r ) \times E & ( 3 ) \\ φ ( r ) = \frac{2 π}{{λ}_{0}} ψ ( r ) & ( 4 ) \\ ψ ( r ) = {a}_{1} \cdot {r}^{2} + {a}_{2} \cdot {r}^{4} + {a}_{3} \cdot {r}^{6} + {a}_{4} \cdot {r}^{8} + {a}_{5} \cdot {r}^{10} + ⋯ & ( 5 )\end{matrix}$$

Here, n₀ is a refractive index of a medium before the ray passes diffraction grating surface 101, n₁ is a refractive index of the medium after the ray passes diffraction grating surface 101, m is a diffraction order, λ is a wavelength of light, λ₀ is a center wavelength of the light, E is a normal unit vector of a surface of the lens base, S₀ is a unit vector indicating a traveling direction of the incident light, and S₁ is a unit vector indicating a traveling direction of the outgoing light. Moreover, φ is a phase function, ψ is an optical path difference function, r is a distance in a radial direction from an optical axis, a₁, a₂, a₃, a₄, a5, . . . are coefficients indicating an aspherical shape of the lens base of the diffraction grating lens.

Expression (3) is an expression obtained by adding a component of the diffraction grating by the phase function to an expression of refraction of a normal lens. In this manner, the calculation is performed on the assumption that the light is refracted and diffracted at the diffraction grating surface, and reaches an image surface.

In this simulation, since the phase function continuously changes, the calculation is performed on the assumption that there is no influence by diffraction level differences and that a diffraction efficiency of m-th-order diffracted light is 100%. For example, if m=1, the calculation is performed on the assumption that the first-order diffracted light is 100%. Accordingly, as shown in FIG. 8, phases of wavefronts 104 of respective rays 103 in a luminous flux are continuously aligned. However, in reality, due to the diffraction level difference, the wavefronts are divided every diffraction orbicular zone, and as to the incident light at a high field angle, the diffraction efficiency of the first-order diffracted light at the diffraction grating surface is not 100%.

FIG. 9 is a diagram showing flare based on the diffraction efficiency of the diffraction grating. As to the incident light at a high field angle, when the incident light passes each diffraction orbicular zone 112 of diffraction grating lens 111, the phase is shifted from an ideal wavefront. For example, as to wavefront 113a from first diffraction orbicular zone 112a, the phase advances from desired wavefront 114, and as for wavefront 113b from second diffraction orbicular zone 112b, the phase is delayed from desired wavefront 114. This generates not only desired first-order diffracted light 115 but second or zero-order diffracted light 116, which results in the flare (hereinafter, referred to as D (Discoloration) flare). That is, the diffraction efficiency is not 100%. As shown in FIG. 10, D flare 116 is generated around first-order diffracted light 115.

FIG. 11 is a diagram showing the flare by a slit effect of the diffraction grating. In diffraction grating lens 121, as to wavefront 123 divided by diffraction level difference 124 every diffraction orbicular zone 122, wraparound of the wavefront is caused at end portions. This generates striped flare 126 (hereinafter, referred to as S (Slit) flare) around first-order diffracted light 125, as shown in FIG. 12 (refer to PTL 1). Broken line 127 shows intensity distribution in the conventional simulation.

### CITATION LIST

### Patent Literature

PTL 1: WO 2012/077351

### Non-Patent Literature

NPL 1: “Introduction to Diffractive Optical Elements”, Japan Society of Applied Physics, Optical Society of Japan, Optics Design Group, published by Optronics Co., Ltd, pp. 18-29

### SUMMARY OF THE INVENTION

### Technical Problem

In this manner, in the simulation using the above-described conventional technique, the D flare and the S flare cannot be computed. Accordingly, it is not until the diffraction grating lens is created that influences by the D flare and the S flare can be evaluated, and if the influences by the D flare and the S flare are large, the design needs to be made again. Thus, the design of the diffraction grating lens takes time.

In order to solve this problem, the present invention provides a diffraction grating lens that brings about smaller generation amounts of the D flare and the S flare, and a method for designing an optical system having the diffraction grating lens, an image computation program, and a method for manufacturing the diffraction grating lens.

### Solution to Problem

In order to solve the above-described conventional problem, according to a first method for designing an optical system of the present invention, in a method for designing an optical system having a stepped diffraction grating surface in one surface of a lens, the method includes a flare computation step of defining a temporary shape of the diffraction grating surface and computing a flare amount caused by the temporary shape, and a determination step of determining whether or not the flare amount is within a permissible range, and setting the temporary shape as a shape of the diffraction grating surface when the flare amount is within the permissible range, and returning to the flare computation step when the flare amount is out of the permissible range. The flare computation step includes a temporary shape definition step of defining the temporary shape of the diffraction grating surface, a phase computation step of conducting ray tracing from an object surface to an image surface of the optical system at a predetermined field angle, using the temporary shape of the diffraction grating surface to find a traveling direction and phase information of a ray at the predetermined field angle, a pupil distribution computation step of finding pupil distribution on an exit pupil at the predetermined field angle, based on the phase information at the predetermined field angle, and a point image distribution computation step of finding point image distribution on the image surface at the predetermined field angle from the pupil distribution at the predetermined field angle, using a wave propagation analysis method to compute the flare amount.

Moreover, the predetermined field angle may be an on-axis field angle and a predetermined off-axis field angle that brings about an image height of 50% or more with respect to an image height at a maximum field angle. In this case, the determination step may include comparing a flare amount in point image distribution at the on-axis field angle with a flare amount in point image distribution at the predetermined off-axis field angle to determine whether or not the flare amount is within the permissible range.

Moreover, the permissible range can be a range where the flare amount in the point image distribution at the predetermined off-axis field angle is smaller than the flare amount in the point image distribution at the on-axis field angle.

The predetermined field angle may be a plurality of field angles in a predetermined region including a predetermined off-axis field angle that brings about an image height of 50% or more with respect to an image height at a maximum field angle. In this case, the method may include a convolution step of convoluting point image distribution at each of the plurality of field angles into an object image to find an image. The determination step may include determining whether or not the flare amount in the image is within the permissible range.

The predetermined field angle may be a plurality of field angles ranging an on-axis field angle to the maximum field angle. In this case, the method may include a convolution step of convoluting point image distribution at each of the plurality of field angles into an object image to find an image. The determination step may include determining whether or not the flare amount in the image is within the permissible range.

When a step of designing returns to the temporary shape definition step of the flare computation step from the determination step, the temporary shape is redefined after adjusting a height of a diffraction level difference in the temporary shape.

In order to solve the above-described conventional problem, according to a second method for designing an optical system of the present invention, in a method for designing an optical system having a stepped diffraction grating surface in one surface of a lens, the method includes a flare computation step of defining a temporary shape of the diffraction grating surface, and computing a flare amount by the temporary shape, a repetition step of performing the flare computation step a predetermined number of times while changing a height of a diffraction level difference of the temporary shape, and a decision step of deciding a temporary shape that brings about a least flare amount as a shape of the diffraction grating surface. The flare computation step includes a temporary shape definition step of defining the temporary shape of the diffraction grating surface, a phase computation step of conducting ray tracing from an object surface to an image surface of the optical system at a predetermined field angle, using the temporary shape of the diffraction grating surface to find a traveling direction and phase information of a ray at the predetermined field angle, a pupil distribution computation step of finding pupil distribution on an exit pupil at the predetermined field angle, based on the phase information at the predetermined field angle, and a point image distribution computation step of finding point image distribution on the image surface at the predetermined field angle from the pupil distribution at the predetermined field angle, using a wave propagation analysis method to compute the flare amount.

The predetermined field angle may be a predetermined off-axis field angle that brings about an image height of 50% or more with respect to an image height at a maximum field angle. In this case, a temporary shape that brings about a least flare amount in point image distribution at the predetermined off-axis field angle can be set as the shape of the diffraction grating surface.

The predetermined field angle may be a plurality of field angles in a predetermined region including a predetermined off-axis field angle that brings about an image height of 50% or more with respect to an image height at a maximum field angle. In this case, the point image distribution at each of the plurality of field angles can be convoluted into an object image to find an image, and a temporary shape that brings about a least flare amount in the image can be set as the shape of the diffraction grating surface.

The predetermined field angle may be a plurality of field angles from the on-axis field angle to the maximum field angle. In this case, point image distribution at each of the plurality of field angles can be convoluted into an object image to find an image, and a temporary shape that brings about a least flare amount in the image can be set as the shape of the diffraction grating surface.

The image can be an object image of an unsaturated high dynamic range, and the object image is obtained by photographing a plurality of images for an identical object with different exposure times, and is formed of by synthesizing the photographed images.

In the temporary shape of the diffraction grating surface, a height d of the diffraction level difference, a center wavelength λ in a design wavelength region, a refractive index no of a medium before the ray passes the diffraction grating surface at the center wavelength λ, and a refractive index n₁ of the medium after the ray passes the diffraction grating surface can satisfy a relation of d<λ/|n₁−n₀|. When the medium is air, the refractive index is 1.

In the temporary shape step, a plurality of the diffraction level differences can be all set to have the same height.

An image computation program of the present invention computes an image in an image surface of an optical system having a stepped diffraction grating surface in one surface of a lens. In order to solve the above-described problem, the program includes a shape definition step of defining a shape of the diffraction grating surface, a phase computation step of conducting ray tracing from an object surface to the image surface of the optical system at a plurality of field angles ranging from an on-axis field angle to a maximum field angle, using the shape of the diffraction grating surface to find a traveling direction and phase information of a ray at each of the plurality of field angles, a pupil distribution computation step of finding pupil distribution on an exit pupil at each of the plurality of field angles, based on the phase information at each of the plurality of field angles, a point image distribution computation step of finding point image distribution on the image surface at each of the plurality of field angles from the pupil distribution at each of the plurality of field angles, using a wave propagation analysis method, and a convolution step of convoluting point image distribution at each of the plurality of field angles into an object image to find the image.

In order to solve the above-described problem, according to a first method for manufacturing an optical system of the present invention, in a method for manufacturing an optical system having a stepped diffraction grating surface in one surface of a lens, the method includes a flare computation step of defining a temporary shape of the diffraction grating surface and computing a flare amount caused by the temporary shape, a determination step of determining whether or not the flare amount is within a permissible range, and setting the temporary shape as a shape of the diffraction grating surface when the flare amount is within the permissible range, and returning to the flare computation step when the flare amount is out of the permissible range, and a manufacturing step of manufacturing the optical system, based on the shape of the diffraction grating surface decided in the determination step. The flare computation step includes a temporary shape definition step of defining the temporary shape of the diffraction grating surface, a phase computation step of conducting ray tracing from an object surface to an image surface of the optical system at a predetermined field angle, using the temporary shape of the diffraction grating surface to find a traveling direction and phase information of a ray at the predetermined field angle, a pupil distribution computation step of finding pupil distribution on an exit pupil at the predetermined field angle, based on the phase information at the predetermined field angle, and a point image distribution computation step of finding point image distribution on the image surface at the predetermined field angle from the pupil distribution at the predetermined field angle, using a wave propagation analysis method to compute the flare amount.

The predetermined field angle may be an on-axis field angle and a predetermined off-axis field angle that brings about an image height of 50% or more with respect to an image height at a maximum field angle. In this case, the determination step may include comparing a flare amount in point image distribution at the on-axis field angle with a flare amount in point image distribution at the predetermined off-axis field angle to determine whether or not the flare amount is within the permissible range.

The permissible range can be a range where the flare amount in the point image distribution at the predetermined off-axis field angle is smaller than the flare amount in the point image distribution at the on-axis field angle.

The predetermined field angle may be a plurality of field angles in a predetermined region including the predetermined off-axis field angle that brings about an image height of 50% or more with respect to an image height at a maximum field angle. In this case, the method may include a convolution step of convoluting point image distribution at each of the plurality of field angles into an object image to find an image. The determination step may include determining whether or not the flare amount in the image is within the permissible range.

The predetermined field angle may be a plurality of field angles ranging from an on-axis field angle to the maximum field angle. In this case, the method may include a convolution step of convoluting point image distribution at each of the plurality of field angles into an object image to find an image. The determination step may include determining whether or not the flare amount, in the image is within the permissible range.

When a step of manufacturing returns to the temporary shape definition step of the flare computation step from the determination step, the temporary shape can be redefined after adjusting a height of a diffraction level difference in the temporary shape.

In order to solve the above-described problem, according to a second method for manufacturing an optical system of the present invention, in a method for manufacturing an optical system having a stepped diffraction grating surface in one surface of a lens, the method includes a flare computation step of defining a temporary shape of the diffraction grating surface, and computing a flare amount caused by the temporary shape, a repetition step of performing a flare computation step a predetermined number of times while changing a height of a diffraction level difference of the temporary shape, a decision step of deciding a temporary shape that brings about a least flare amount as a shape of the diffraction grating surface, and a manufacturing step of manufacturing the optical system, based on the shape of the diffraction grating surface. The flare computation step includes a temporary shape definition step of defining the temporary shape of the diffraction grating surface, a phase computation step of conducting ray tracing from an object surface to an image surface of the optical system at a predetermined field angle, using the temporary shape of the diffraction grating surface to find a traveling direction and phase information of a ray at the predetermined field angle, a pupil distribution computation step of finding pupil distribution on an exit pupil at the predetermined field angle, based on the phase information at the predetermined field angle, and a point image distribution computation step of finding point image distribution on the image surface at the predetermined field angle from the pupil distribution at the predetermined field angle, using a wave propagation analysis method to compute the flare amount.

The predetermined field angle may be a predetermined off-axis field angle that brings about an image height of 50% or more with respect to an image height at a maximum field angle. In this case, a temporary shape that brings about a least flare amount in point image distribution at the predetermined off-axis field angle can be set as the shape of the diffraction grating surface.

The predetermined field angle may be a plurality of field angles in a predetermined region including a predetermined off-axis field angle that brings about an image height of 50% or more with respect to an image height at a maximum field angle. In this case, point image distribution at each of the plurality of field angles can be convoluted into an object image to find an image, and a temporary shape that brings about a least flare amount in the image can be set as the shape of the diffraction grating surface.

The predetermined field angle may be a plurality of field angles ranging from an on-axis field angle to the maximum field angle. In this case, point image distribution at each of the plurality of field angles can be convoluted into an object image to find an image, and a temporary shape that brings about a least flare amount in the image can be set as the shape of the diffraction grating surface.

The image can be an object image of an unsaturated high dynamic range, and the object image is obtained by photographing a plurality of images for an identical object with different exposure times, and is formed by synthesizing the photographed images.

In the temporary shape of the diffraction grating surface, a height d of the diffraction level difference, a center wavelength λ in a design wavelength region, a refractive index n₀ of a medium before the ray passes the diffraction grating surface at the center wavelength λ, and a refractive index n₁ of the medium after the ray passes the diffraction grating surface can satisfy a relation of d<λ|n₁−n₀|.

In the temporary shape step, a plurality of the diffraction level differences may be all set to have the same height.

In order to solve the above-described problem, a diffraction grating lens of the present invention has a diffraction grating surface provided with a stepped diffraction level difference in one surface of a lens. In a temporary shape of the diffraction grating surface, a height d of the diffraction level difference, a center wavelength λ in a design wavelength region, a refractive index no of a medium before the ray passes the diffraction grating surface at the center wavelength λ, and a refractive index n₁ of the medium after the ray passes the diffraction grating surface satisfy a relation of d<λ|n₁−n₀|.

The diffraction grating lens of the present invention can be configured such that a plurality of the diffraction level differences all have the same height.

### Advantageous Effect of Invention

According to the present invention, there can be provided a diffraction grating lens that brings about small generation amounts of D flare and S flare, using simulation in which a diffraction level difference and wraparound of a wavefront are considered, a method for designing an optical system having the diffraction grating lens, an image computation program, and a method for manufacturing the diffraction grating lens.

### BRIEF DESCRIPTION OF DRAWINGS

FIG. 1 is a cross-sectional diagram schematically showing an optical system of an imaging device including a diffraction grating lens in a first exemplary embodiment of the present invention.

FIG. 2 is a schematic diagram showing a wavefront in a lens system in the first exemplary embodiment.

FIG. 3 is a flowchart showing a method for designing the diffraction grating lens in the first exemplary embodiment.

FIG. 4A is a diagram showing an actual image of a point light source entering the optical system having the diffraction grating lens at a field angle of 60 degrees.

FIG. 4B is a diagram showing intensity distribution of the image of the point light source in FIG. 4A.

FIG. 4C is a diagram showing intensity distribution of simulation in the first exemplary embodiment.

FIG. 5A is a diagram showing an actual image of a fluorescent lamp photographed by the optical system having the diffraction grating lens.

FIG. 5B is a diagram showing a simulation image by simulation in the first exemplary embodiment.

FIG. 5C is a diagram showing a simulation image of conventional simulation.

FIG. 6 is a flowchart showing a method for designing a diffraction grating lens in a second exemplary embodiment of the present invention.

FIG. 7 is a diagram showing a diffraction grating surface in simulation using convention ray tracing.

FIG. 8 is a schematic diagram showing a wavefront in the simulation using the conventional ray tracing.

FIG. 9 is a diagram showing flare based on a diffraction efficiency of a diffraction grating.

FIG. 10 is a diagram showing intensity distribution on an image surface of light shown in FIG. 9.

FIG. 11 is a diagram showing flare by a slit effect of the diffraction grating.

FIG. 12 is a diagram showing intensity distribution on an image surface of light shown in FIG. 11.

### DESCRIPTION OF EMBODIMENTS

### First Exemplary Embodiment

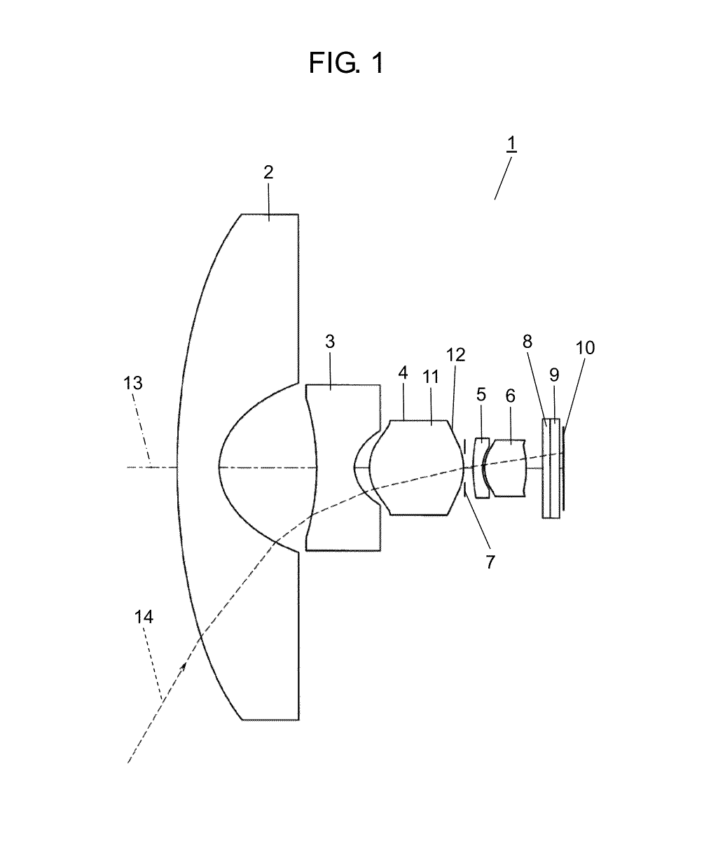

FIG. 1 is a cross-sectional diagram schematically showing optical system 1 of an imaging device including diffraction grating lens 4 in a first exemplary embodiment of the present invention. Optical system 1 is configured by sequentially disposing first to fifth lenses 2 to 6 from an object side (a left side in FIG. 1). First lens 2 is a meniscus lens in which a lens on an image surface side is concave. Second lens 3 is a biconcave lens. Third lens 4 is a diffraction grating lens having a positive power, and a stepped diffraction grating is formed in surface 12 of lens base 11 on an image surface side (a right side in FIG. 1). Fourth lens 5 is a meniscus lens having a convex surface on the object side. Diaphragm 7 is disposed between third lens 4 and fourth lens 5. Diaphragm 7 defines an exit pupil.

Fifth lens 6 is a biconvex lens. IR cut filter 8 and cover glass 9 are disposed on the image surface side of fifth lens 6, and imaging element 10 is disposed at a position of an image surface. Imaging element 10 receives an object image to convert the same to an electrical signal. The converted electrical signal is converted to image data in a processor not shown, and is stored in a storage device. Cover glass 9 protects a surface of imaging element 10.

A broken line in FIG, 1 indicates incident ray 14 of incident light. The incident light coming from the object side transmits first to fifth lenses 2 to 6 and reaches imaging element 10. Although the incident light coming at a high field angle is refracted by first lens 2 and second lens 3, which makes an angle with respect to optical axis 13 smaller, the incident light still enters diffraction grating surface 12 at a considerably large angle.

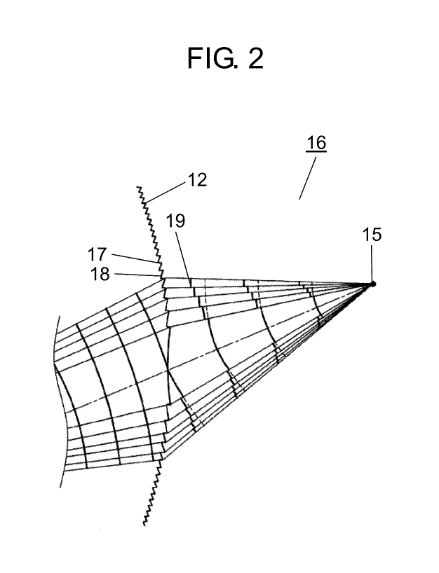

FIG. 2 is a schematic diagram showing wavefront 19 in lens system 1. For simplification, the lens system between diffraction grating surface 12 and image formation point 15 is omitted. In FIG. 2, luminous flux 16 of incident ray 14 as incident light at a high field angle is shown.

Luminous flux 16 advances from the object side to the image side while changing a direction by the refraction by the shapes of the lenses and the diffraction by the diffraction grating. In diffraction grating surface 12, stepped diffraction level differences 17, which make up the diffraction grating, are provided to form diffraction orbicular zones 18. Thus, continuous wavefront 19 becomes discontinuous every passed diffraction orbicular zone 18 by passing diffraction grating surface 12. The above-described discontinuity of wavefront 19 causes D flare and S flare.

In diffraction grating surface 12, when a center wavelength of a set wavelength region is λ, a refractive index of a medium before the ray passes diffraction grating surface 12 at center wavelength λ is n₀, and a refractive index of the medium after the ray passes diffraction grating surface 12 is n₁, height d of each of diffraction level differences 17 is as follows

d<λ/|n₁−n₀| (1)

where the set wavelength region is a photographable wavelength region.

That is, the height of the diffraction level difference is formed to be lower than a height (λ/n₁ n₀|) of a diffraction level difference of a conventional diffraction grating lens. This can reduce generation amounts of the D flare and the S flare. Height d of the diffraction level difference may be changed on the basis of the diffraction orbicular zone. However, when the diaphragm exists in the vicinity of diffraction grating surface 12, change in the flare amount is small even if the height of the diffraction level difference is changed on the basis of the diffraction orbicular zone, and thus, conversion from a phase function to a shape is easy, so that the height of the diffraction level difference may be the same.

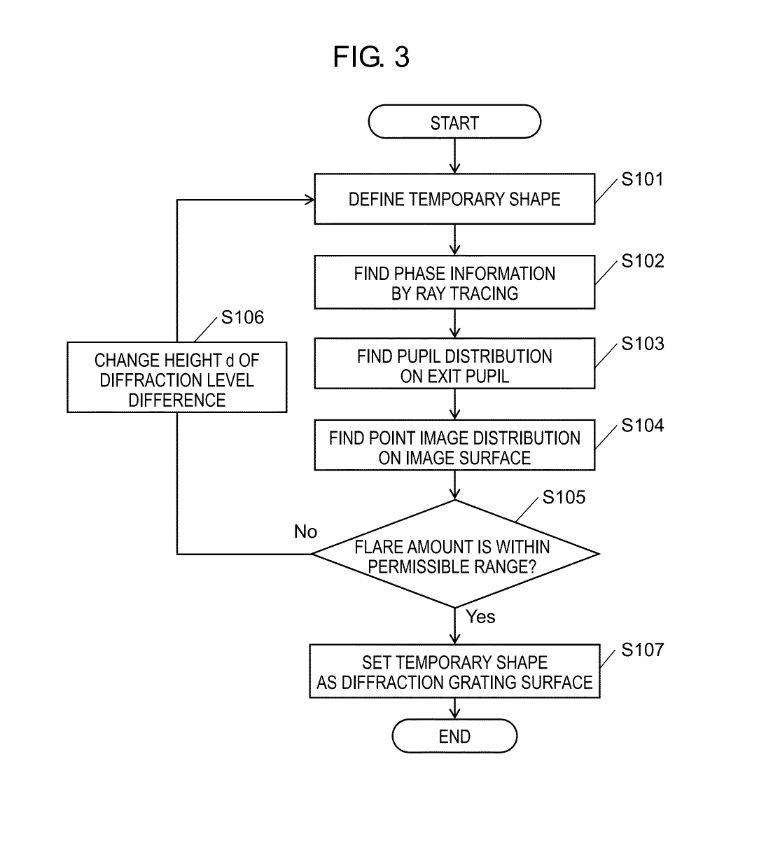

Next, a method for designing diffraction grating lens 4 will be described. FIG. 3 is a flowchart showing the method for designing diffraction grating lens 4. First, using conventional ray tracing or the like, design values of an aspherical shape of the lens base of the diffraction grating lens 4, and orbicular zone widths of the diffraction orbicular zones, and the like are computed. Height d of the diffraction level difference is set to a certain value in the range of expression (1). That is, height d of the diffraction level difference is made different from that in the conventional design. In this manner, the diffraction grating surface shape is defined by the actual stepped shape (step S101). The diffraction grating surface shape defined here is a temporary shape for which consideration of height d of the diffraction level difference is not sufficient, and in the following process, whether or not this temporary shape allows the flare amount to fall in the permissible range is determined.

Next, the ray tracing is conducted at each of an on-axis field angle and an off-axis field angle that brings about an image height of 70% with respect to an image height at a maximum field angle (hereinafter, referred to as a 70% field angle) to find a traveling direction and an optical path difference (a phase) of the light from an object surface to an image surface of the optical system (step S102). At this time, the refraction in each of the lens surfaces including the diffraction grating surface, that is, the traveling direction of the light is found, using expression (2).

n₁(S₁×E)=n₀(S₀×E) (2)

Here, n₀ is a refractive index of a medium before a ray passes diffraction grating surface 12, n₁ is a refractive index of the medium after the ray passes diffraction grating surface 12, E is a normal unit vector of diffraction grating surface 12, S₀ is a unit vector indicating a traveling direction of the incident light, and S₁ is a unit vector indicating a traveling direction of the outgoing light. Diffraction grating surface 12 has the temporary shape found in step S101.

Moreover, using the traveling direction of the light, optical path difference information of the ray is computed. A value of the optical path difference can he decided in accordance with a distance where the ray has traveled. At this time, as to luminous flux 16 that has passed diffraction grating surface 12, the wavefront is divided every concentric diffraction orbicular zone, so that the phase of the light becomes discontinuous. In this manner, phase information different from that in the related art is obtained.

Next, a shape of a pupil and phase distribution (pupil distribution) at each of the field angles on the exit pupil defined by diaphragm 7 are found, based on the phase information at each of the field angles found in step S102 (step S103). In the found pupil distribution at each of the field angles, the phase of the light from each of diffraction orbicular zones 18 becomes concentrically discontinuous, and further, an influence by wraparound of the wavefront caused at end portions of light from each of diffraction orbicular zones 18 is reflected.

Next, the pupil distribution at each of the field angles on the exit pupil is propagated to the image surface, using wave propagation analysis to find point image distribution on the image surface at each of the field angles (step S104). In the wave propagation analysis, use of Fraunhofer diffraction for the wave propagation can make it easy to find the point image distribution by two-dimensional Fourier transform of the pupil distribution on the exit pupil. The wave propagation analysis method is not limited thereto, but for the wave propagation, for example, Rayleigh-Sommerfeld formula or Fresnel approximation may be used.

Next, whether or not the flare amount in the point image distribution is within a permissible range is determined (step S105). As a method for evaluation, the evaluation is performed, based on whether or not the flare amount in the point image distribution at the 70% field angle is smaller than the flare amount, in the point image distribution at the on-axis field angle. If smaller, the flare amount is determined to be within the permissible range, and the temporary shape is set as a desired shape of the diffraction grating surface (step S107). If larger, height d of the diffraction level difference of the diffraction grating surface is changed in the range satisfying expression (1) (step S106). A new temporary shape of the diffraction grating surface shape in step S101 is defined, using the height of the diffraction level difference newly set to perform steps S102 to S105 again. This processing is repeated until the flare amount becomes within the permissible range. Adjustment in this manner reduces the flare amount by the incident light at the high field angle, thereby reducing the whole flare amount.

In this manner, when the shape of the diffraction grating surface that brings about the small flare amount is decided, the diffraction grating lens can be manufactured by a normal method.

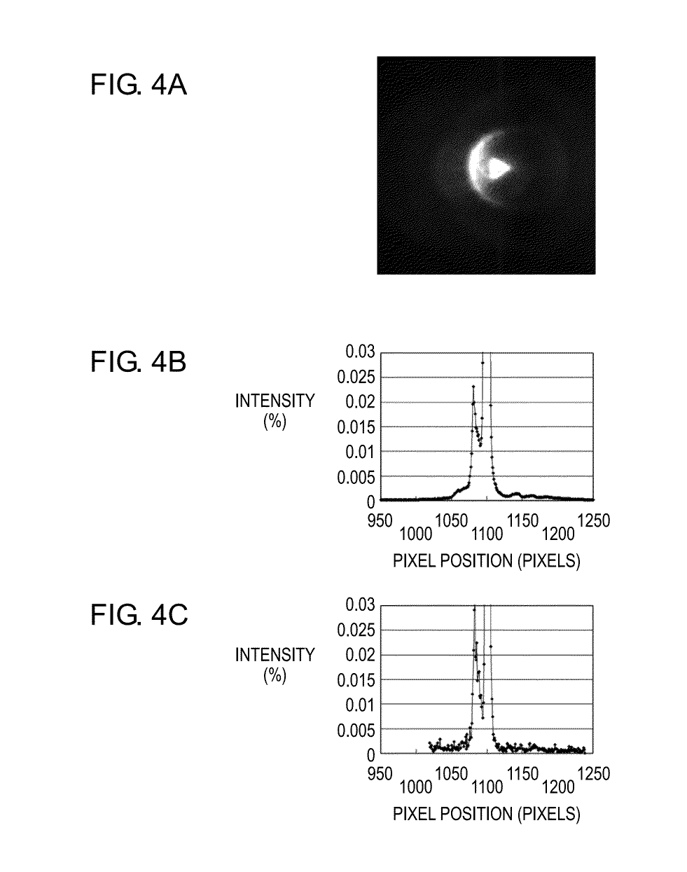

Next, simulation described in steps 5101 to S104 in FIG. 3 will be considered. FIG. 4A shows an actual image of a point light source entering the optical system having the diffraction grating lens at a field angle of 60 degrees, FIG. 4B shows intensity distribution of the same, and FIG. 4C is point image distribution of the simulation in the present exemplary embodiment. In FIG. 4A, beside the image of the light source, flare is caused on the left side of the image of the light source. As shown in FIG. 4B, in the intensity distribution, the image of the light source exists at a position of 1100 pixels (first-order diffracted light), and the flare exists around a position of 1080 pixels. As shown in FIG. 4C, in the point image distribution found in the simulation, a large intensity peak exists at the position of 1100 pixels, and a small intensity peak exists around the position of 1080 pixels. These correspond to the image of the point light source and the flare. That is, it is shown that the simulation in the present exemplary embodiment enables the intensity distribution including the flare to be reproduced.

In the simulation in the present exemplary embodiment, not only the computation of the flare amount but computation of a simulation image, MTF calculation, tolerance analysis, lost light calculation and the like can be conducted.

As to the computation of the simulation image, at each of the field angles of the on-axis field angle to the maximum field angle, steps S101 to S104 are executed to find the point image distribution at each of the field angles. The point image distribution at each of the field angles is convoluted into an object image, by which the simulation image of the object including the flare can be computed. For convolution operation, calculation on a frequency space, using two-dimensional FFT (Fast Fourier Transform) or DFT (Discrete Fourier Transform) can shorten calculation time.

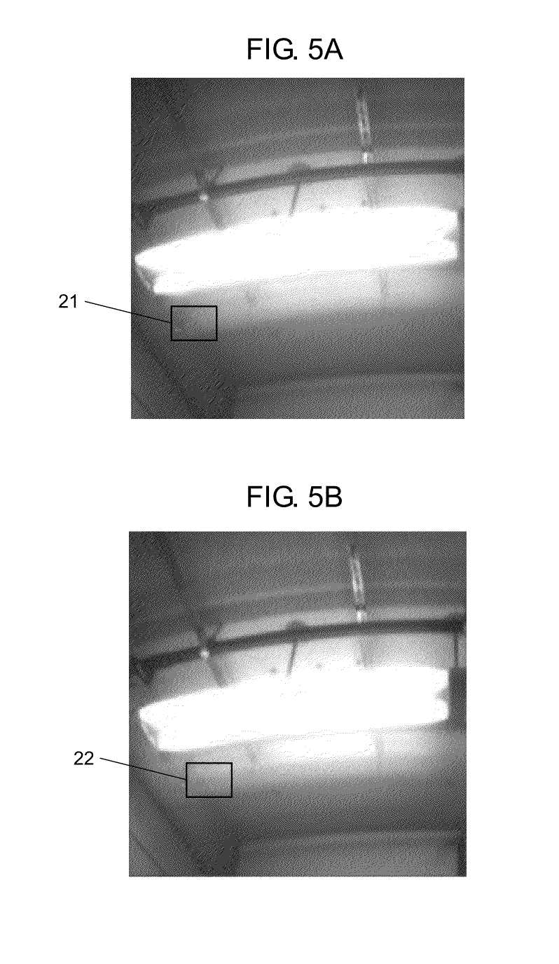

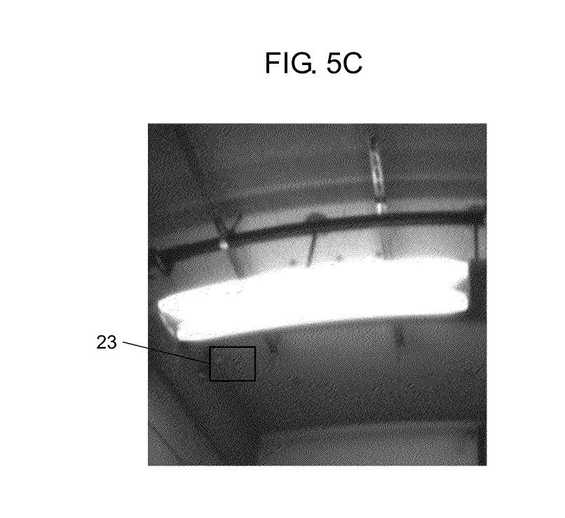

FIG. 5A shows an actual image of a fluorescent lamp photographed by the optical system having the diffraction grating lens. FIG. 5B shows a simulation image by the simulation in the present exemplary embodiment. FIG. 5C is a simulation image by the conventional simulation. As in region 21 of FIG. 5A, a flare image is displayed white in region 22 of FIG. 5B. On the other hand, in region 23 of FIG. 5C, no flare exists. That is, the flare that cannot he reproduced in the conventional simulation can be reproduced by the simulation in the present exemplary embodiment.

Thereby, the permissible range of the flare by the designed optical system can be instinctively recognized, and quality of the design can be visually determined. That is, in the flowchart shown in FIG. 3, in step S105, based on whether or not the flare amount in the point image distribution at the 70% field angle is smaller than the flare amount in the point image distribution at the on-axis field angle, it is determined whether or not the flare amount is within the permissible range. However, the simulation image can also be created to determine whether or not the flare amount is within the permissible range. In this case, it may be determined by visual checking of an operator whether or not the flare amount is within the permissible range.

Moreover, if only the adjustment of height d of the diffraction level difference does not enable the flare amount to fall within the permissible range, the simulation image will be used as a material for reconsidering the design of the whole optical system.

As described above, in the method for designing the optical system in the present exemplary embodiment, the generation amounts of the D flare and the S flare can be computed before manufacturing the diffraction grating lens. This can reduce a number of times of trial of the lens, so that time required for designing the lens can be shorted, and the design can be optimized.

In the present exemplary embodiment, the permissible range is determined in the flare amounts in the point image distribution at the off-axis field angle that brings about the image height of 70% with respect to the image height at the maximum field image, and the on-axis field angle. However, the off-axis field angle is not limited to the 70% field angle, but the flare amount in the point image distribution at any field angle of the off-axis field angles that bring about image heights of 50% to 100% inclusive with respect to the image height at the maximum field angle only needs to be smaller than the flare amount in the point image distribution on the on-axis field angle.

### Second Exemplary Embodiment

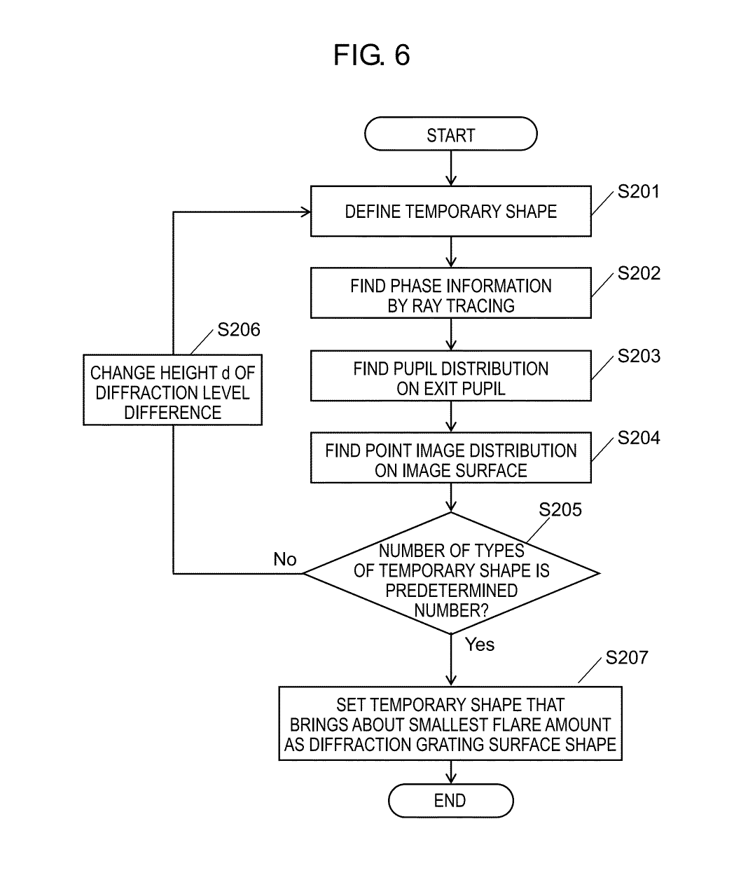

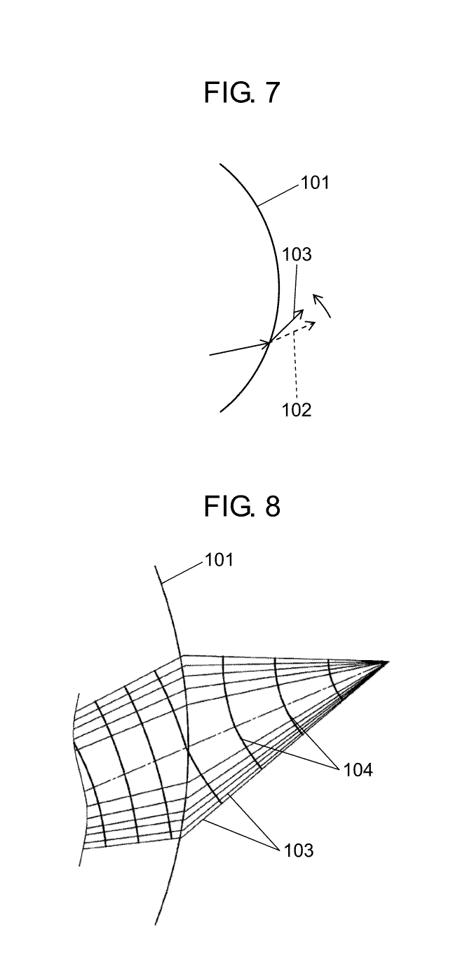

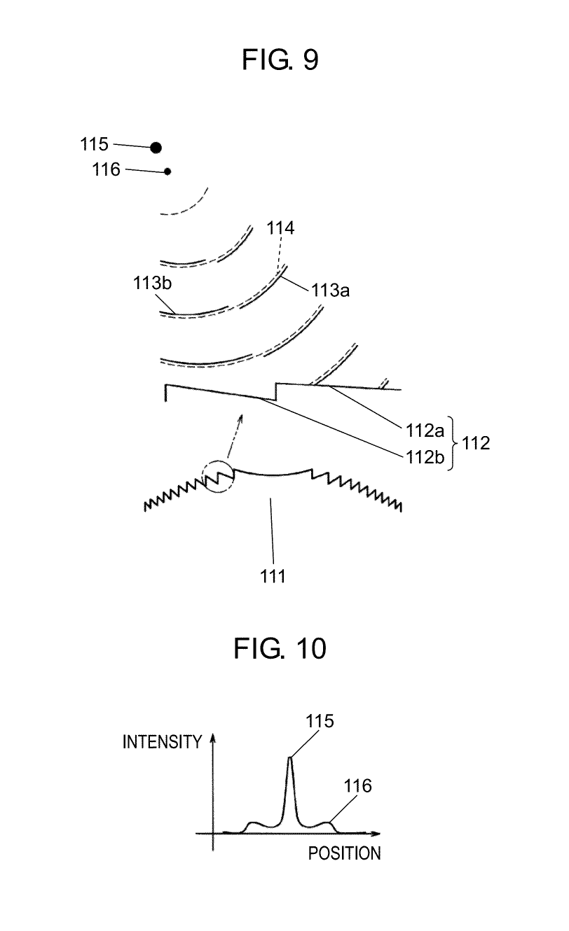

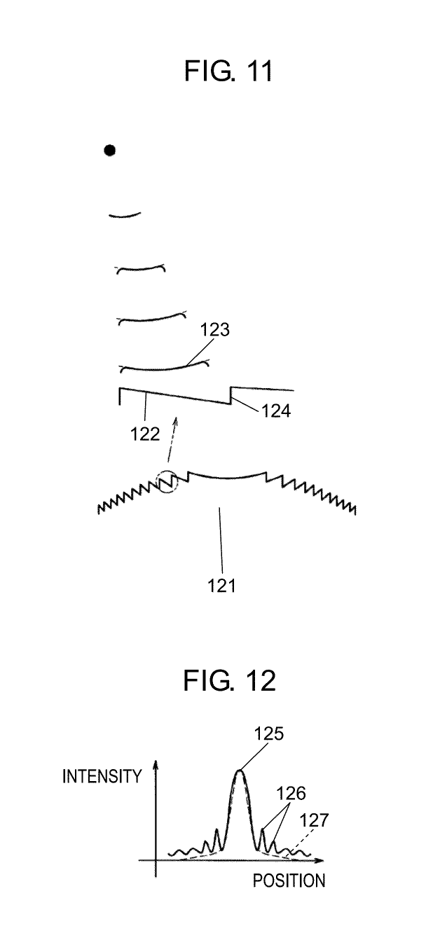

FIG. 6 is a flowchart showing a method for designing diffraction grating lens 4b in a second exemplary embodiment of the present invention. In the present exemplary embodiment, diffraction grating lens 4b is the same as diffraction grating lens 4 in the first exemplary embodiment except that the design method is different, so that the same components are given the same reference numerals, and descriptions thereof are omitted. Moreover, creation of a simulation image is enabled as in the first exemplary embodiment.

First, as in step S101 in the first exemplary embodiment, a diffraction grating surface shape is defined by an actual stepped shape as a temporary shape (step S201). Here, height d of each diffraction level difference is set to be an assumable maximum height. In the following process, flare is computed while decreasing height d of a diffraction level difference to decide a height of the diffraction level difference that brings about the least flare. For this, width w by which the height of the diffraction level difference is changed, and types n of the diffraction grating lenses for each of which a flare amount is computed are set. That is, the flare amount of the diffraction grating lens is computed in a range where the height of the diffraction level difference differs by w×n.

Next, ray tracing is conducted at an off-axis field angle (a 70% field angle) that brings about an image height of 70% with respect to an image height at a maximum field angle to find a traveling direction and an optical path difference (phase) of the light from an object surface to an image surface of an optical system (S202). Next, based on phase information at the 70% field angle, a shape of a pupil and phase distribution (pupil distribution) at the 70% field angle on an exit pupil defined by diaphragm 7 are found (step S203). Next, the pupil distribution at the 70% field angle on the exit pupil is propagated to the image surface, using wave propagation analysis to find point image distribution on the image surface at the 70% field angle (step S204). The flare amount in the point image distribution is computed.

Next, it is determined whether or not a number of the types of the temporary shape for each of which the flare amount is computed has become the predetermined number n (step S205). If the number of the types of the temporary shape for each of which the flare amount is computed is smaller than the predetermined number n, height d of the diffraction level difference is changed, specifically, is decreased by w (step S206) to return the processing to step S201, in which the temporary shape of the diffraction grating lens is defined. In step S205, if the number of the types of the temporary shape for each of which the flare amount is computed is the predetermined number n, a temporary shape that brings about the least flare amount is set as the shape of the diffraction grating surface (step S207). The above-described process allows the diffraction grating surface shape, that is, the shape of the diffraction grating lens to be decided.

As described above, in the method for designing the optical system in the present exemplary embodiment, the generation amounts of D flare and S flare can be computed before the diffraction grating lens is manufactured. This can reduce a number of times of trial of the lens, so that time required for the design of the lens can be shortened, and the design can be optimized.

Moreover, in the second exemplary embodiment, as to the flare amount in the point image distribution at the off-axis field angle that brings about the image height of 70% with respect to the image height at the maximum field angle, the height of the diffraction level difference is changed to find the height of the diffraction level difference that brings about the smallest flare amount. However, the off-axis field angle is not limited to the 70% field angle, but any field angle of the off-axis field angles that bring about image heights of 50% to 100% inclusive with respect to the image height at the maximum field angle may be employed.

Moreover, while for one off-axis field angle, the flare amount is computed while changing the height of the diffraction level difference to find desired height d of the diffraction level difference, the off-axis field is not limited to one, but a plurality of the off-axis field angles may be used. Furthermore, the flare amount may be computed for all the field angles, and simulation images at the plurality of heights of diffraction level difference may be computed, so that height d of the diffraction level difference of the simulation image having the small flare amount of the images may be set as desired height d of the diffraction level difference.

Moreover, in the first and second exemplary embodiments, the simulation image need not be created, using the simulation results at all the field angles, but the simulation images at several field angles in a predetermined range may be created. For example, only a part of the simulation images may be computed, using the point image distribution at any plurality of field angles of the off-axis field angles that bring about the image heights 50% to 100% inclusive with respect to the image height at the maximum field angle.

While in the first and second exemplary embodiments, a pack of five lenses is used as the optical system, the optical system only needs to have one or more lenses, and have a diffraction grating surface in at least one of surfaces of these lenses.

Moreover, in the convolution operation, the operation is conducted, using the object image. If an object of this object image includes an object having a high light intensity such as a fluorescent lamp and the like, an object image of an unsaturated high dynamic range, which is a wide dynamic range with the light intensity unsaturated, is desirable. In order to create the object image of the unsaturated high dynamic range, there is a method of photographing a plurality of images for the identical object with different exposure times, and performing by synthesizing in which a region where the light intensity in the object image is saturated is replaced with a corresponding region in the image of the shorter exposure time, or the like.

### INDUSTRIAL APPLICABILITY

The present invention has an advantage that a generation amount of flare is small, and can be used for optical design of an imaging device such as a camera and the like.

### REFERENCE MARKS IN THE DRAWINGS

1: optical system

2: first lens

3: second lens

4, 4b: third lens, diffraction grating lens

5: fourth lens

6: fifth lens

7: diaphragm

8: IR cut filter

9: cover glass

10: imaging element

11: lens base

12: diffraction grating surface

13: optical axis

14: incident ray

15: image formation point

16: luminous flux

17: diffraction level difference

18: diffraction orbicular zone

19: wavefront

21, 22, 23: region

1. A method for designing an optical system having a stepped diffraction grating surface in one surface of a lens, the method comprising:
a flare computation step of defining a temporary shape of the diffraction grating surface and computing a flare amount by the temporary shape; and
a determination step of determining whether or not the flare amount is within a permissible range, and setting the temporary shape as a shape of the diffraction grating surface when the flare amount is within the permissible range, and returning to the flare computation step when the flare amount is out of the permissible range,
wherein the flare computation step comprises:
a temporary shape definition step of defining the temporary shape of the diffraction grating surface;
a phase computation step of conducting ray tracing from an object surface to an image surface of the optical system at a predetermined field angle, using the temporary shape of the diffraction grating surface to find a traveling direction and phase information of a ray at the predetermined field angle;
a pupil distribution computation step of finding pupil distribution on an exit pupil at the predetermined field angle, based on the phase information at the predetermined field angle; and
a point image distribution computation step of finding point image distribution on the image surface at the predetermined field angle from the pupil distribution at the predetermined field angle, using a wave propagation analysis method to compute the flare amount.

2. The method for designing an optical system according to claim 1, wherein the predetermined field angle is an on-axis field angle and a predetermined off-axis field angle that brings about an image height of 50% or more with respect to an image height at a maximum field angle, and
the determination step includes comparing a flare amount in point image distribution at the on-axis field angle with a flare amount in point image distribution at the predetermined off-axis field angle to determine whether or not the flare amount is within the permissible range.

3. The method for designing an optical system according to claim 2, wherein the permissible range is a range where the flare amount in the point image distribution at the predetermined off-axis field angle is smaller than the flare amount in the point image distribution at the on-axis field angle.

4. The method for designing an optical system according to claim 1, wherein
the predetermined field angle is a plurality of field angles in a predetermined region including a predetermined off-axis field angle that brings about an image height of 50% or more with respect to an image height at a maximum field angle,
the method includes a convolution step of convoluting point image distribution at each of the plurality of field angles into an object image to find an image, and
the determination step includes determining whether or not the flare amount in the image is within the permissible range.

5. The method for designing an optical system according to claim 1, wherein
the predetermined field angle is a plurality of field angles ranging from the on-axis field angle to the maximum field angle,
the method includes a convolution step of convoluting point image distribution at each of the plurality of field angles into an object image to find an image, and
the determination step includes determining whether or not the flare amount in the image is within the permissible range.

6. The method for designing an optical system according to claim 1, wherein when a step of designing returns to the temporary shape definition step of the flare computation step from the determination step, the temporary shape is redefined after adjusting a height of a diffraction level difference in the temporary shape.

7. A method for designing an optical system having a stepped diffraction grating surface in one surface of a lens, the method comprising:
a flare computation step of defining a temporary shape of the diffraction grating surface, and computing a flare amount by the temporary shape;
a repetition step of performing the flare computation step a predetermined number of times while changing a height of a diffraction level difference of the temporary shape; and
a decision step of deciding a temporary shape that brings about a least flare amount as a shape of the diffraction grating surface,
wherein the flare computation step comprises:
a temporary shape definition step of defining the temporary shape of the diffraction grating surface;
a phase computation step of conducting ray tracing from an object surface to an image surface of the optical system at a predetermined field angle, using the temporary shape of the diffraction grating surface to find a traveling direction and phase information of a ray at the predetermined field angle;
a pupil distribution computation step of finding pupil distribution on an exit pupil at the predetermined field angle, based on the phase information at the predetermined field angle; and
a point image distribution computation step of finding point image distribution on the image surface at the predetermined field angle from the pupil distribution at the predetermined field angle, using a wave propagation analysis method to compute the flare amount.

8. The method for designing an optical system according to claim 7, wherein
the predetermined field angle is a predetermined off-axis field angle that brings about an image height of 50% or more with respect to an image height at a maximum field angle, and
a temporary shape that brings about a least flare amount in point image distribution at the predetermined off-axis field angle is set as the shape of the diffraction grating surface.

9. The method for designing an optical system according to claim 7, wherein
the predetermined field angle is a plurality of field angles in a predetermined region including a predetermined off-axis field angle that brings about an image height of 50% or more with respect to an image height at a maximum field angle,
point image distribution at each of the plurality of field angles is convoluted into an object image to find an image, and
a temporary shape that brings about a least flare amount in the image is set as the shape of the diffraction grating surface.

10. The method for designing an optical system according to claim 7, wherein
the predetermined field angle is a plurality of field angles ranging from the on-axis field angle to the maximum field angle,
point image distribution at each of the plurality of field angles is convoluted into an object image to find an image, and
a temporary shape that brings about a least flare amount in the image is set as the shape of the diffraction grating surface.

11. The method for designing an optical system according to claim 4, wherein the image is an object image of an unsaturated high dynamic range, and wherein the object image is obtained by photographing a plurality of images for an identical object with different exposure times, and is formed be synthesizing the photographed images.

12. The method for designing an optical system according to claim 1, wherein in the temporary shape of the diffraction grating surface, a height d of the diffraction level difference, a center wavelength l in a design wavelength region, a refractive index n0 of a medium before the ray passes the diffraction grating surface at the center wavelength l, and a refractive index n1 of the medium after the ray passes the diffraction grating surface satisfy an expression (1).
d<l/|n1−n0| (1)

13. The method for designing an optical system according to claim 1, wherein in the temporary shape step, a plurality of the diffraction level differences are all set to have the same height.

14. An image computation program that computes an image in an image surface of an optical system having a stepped diffraction grating surface in one surface of a lens, the program comprising:
a shape definition step of defining a shape of the diffraction grating surface,
a phase computation step of conducting ray tracing from an object surface to the image surface of the optical system at a plurality of field angles from an on-axis field angle to a maximum field angle, using the shape of the diffraction grating surface to find a traveling direction and phase information of a ray at each of the plurality of field angles;
a pupil distribution computation step of finding pupil distribution on an exit pupil at each of the plurality of field angles, based on the phase information at each of the plurality of field angles;
a point image distribution computation step of finding point image distribution on the image surface at each of the plurality of field angles from the pupil distribution at each of the plurality of field angles, using a wave propagation analysis method; and
a convolution step of convoluting point image distribution at each of the plurality of field angles into an object image to find the image.

15-29. (canceled)

30. The method for designing an optical system according to claim 5, wherein the image is an object image of an unsaturated high dynamic range, and wherein the object image is obtained by photographing a plurality of images for an identical object with different exposure times, and is formed be synthesizing the photographed images.

31. The method for designing an optical system according to claim 9, wherein the image is an object image of an unsaturated high dynamic range, and wherein the object image is obtained by photographing a plurality of images for an identical object with different exposure times, and is formed be synthesizing the photographed images.

32. The method for designing an optical system according to claim 10, wherein the image is an object image of an unsaturated high dynamic range, and wherein the object image is obtained by photographing a plurality of images for an identical object with different exposure times, and is formed be synthesizing the photographed images.

33. The method for designing an optical system according to claim 7, wherein in the temporary shape of the diffraction grating surface, a height d of the diffraction level difference, a center wavelength l in a design wavelength region, a refractive index n0 of a medium before the ray passes the diffraction grating surface at the center wavelength l, and a refractive index n1 of the medium after the ray passes the diffraction grating surface satisfy an expression (1).
d<λ/|n₁−n₀| (1)

34. The method for designing an optical system according to claim 7, wherein in the temporary shape step, a plurality of the diffraction level differences are all set to have the same height.
